(19) United States
(12) Patent Application Publication
(10) Pub. No.: US 2025/0168420 A1
(43) Pub. Date: May 22, 2025

(54) METHOD AND DEVICE FOR OFF-DEMAND BASED CONTENT DOWNLOADING

(71) Applicant: SK Telecom Co., Ltd., Seoul (KR)

(72) Inventors: Kyung Chul KWAK, Seoul (KR); In Tai KIM, Seoul (KR); Gun SONG, Seoul (KR); Dai Boong LEE, Seoul (KR); Hyun Chul JOO, Seoul (KR)

(21) Appl. No.: 19/034,283

(22) Filed: Jan. 22, 2025

Related U.S. Application Data
(63) Continuation of application No. PCT/KR2023/010508, filed on Jul. 20, 2023.

(30) Foreign Application Priority Data
Jul. 26, 2022 (KR) 10-2022-0092470

(51) Int. Cl. H04N 21/232; H04N 21/258; H04N 21/466

(52) U.S. Cl. CPC H04N 21/232; H04N 21/25808; H04N 21/4668

(57) ABSTRACT

The present disclosure provides methods and devices for off-demand-based content downloading and provides in at least one embodiment a method of operating a terminal for pre-downloading content, before a request from a user is made. The method includes obtaining an identifier assigned to the terminal, obtaining a list of one or more contents organized through personalized recommendations for the user, and downloading at least a portion of the one or more contents, in one or more time periods determined based on the identifier, during a pre-download period that is predetermined.

### CROSS-REFERENCE TO RELATED APPLICATIONS

The present application is a bypass continuation of International PCT Application No. PCT/KR2023/010508, filed Jul. 20, 2023, which is based upon and claims priority to Korean Patent Application No. 10-2022-0092470, filed on Jul. 26, 2022, which are incorporated herein by reference in their entirety.

### TECHNICAL FIELD

The present disclosure in some embodiments relates to methods and devices for off-demand-based content downloading.

### BACKGROUND

The statements in this section merely provide background information related to the present disclosure and do not necessarily constitute prior art.

As media viewing behavior gradually shifts from live to on-demand content, various over-the-top services (OTT services) are trying to differentiate themselves. In particular, an increasing number of OTT services are providing download services that allow users to download desired content in advance and playback the content, even where streaming is not available, such as in a poor network environment or on an airplane.

Download services are mainly provided in the form of downloads for playback resumption of content that the user is watching, or downloads in response to the user's download request for specific content. These download services place a heavy load on the back-end system, as they require the terminal device to pre-download content that may not even be viewed. Therefore, while providing download services, there is a need to prevent the download service from becoming overly active. Since most of the existing OTT services are provided in an on-demand manner based on user requests, and the service is initiated by user demand, a lot of statistical data is required to predict the traffic of the service, and it is difficult to control the traffic.

Meanwhile, as content recommendation services based on artificial intelligence (AI) have become more sophisticated, exposing recommended content to users has become a routine practice for OTT services. However, most OTT services provide the recommended content via streaming and do not offer the same via downloading.

### SUMMARY

The present disclosure in some embodiments seeks to provide a method and a device capable of serving personally recommended content to users on an off-demand basis.

The present disclosure in some embodiments seeks to provide a method and a device for providing a stable service by minimizing network load caused by off-demand downloads.

The challenges that the present disclosure seeks to address are not limited to those mentioned above, and other challenges not mentioned will be apparent to those of ordinary skill in the art from the following description.

At least one aspect of the present disclosure provides a method of operating a terminal for pre-downloading content ahead of a user's request, the method including obtaining an identifier assigned to the terminal, obtaining a list of one or more contents curated through personalized recommendations for the user, and downloading at least some of the one or more contents, in one or more time periods which are determined based on the identifier within a predefined pre-download period.

Another aspect of the present disclosure provides a terminal including a download policy manager configured to obtain an identifier assigned to the terminal and a list of one or more contents curated through personalized recommendations for a user of the terminal, and a download agent configured to download at least some of the one or more contents, in one or more time periods which are determined based on the identifier within a predefined pre-download period.

Yet another aspect of the present disclosure provides a computer-readable recording medium storing instructions for causing, when executed by a computer, the computer to perform the method as described above.

According to embodiments of the present disclosure, personally recommended content can be serviced to a user on an off-demand basis.

According to embodiments of the present disclosure, traffic can be controlled to minimize the network load caused by off-demand downloads, enabling the provision of a stable service. For example, the timing of providing the recommended content can be limited to the off-peak hour by the network usage criteria, which can increase the network utilization rate and ensure the stability of the network infrastructure operation.

According to embodiments of the present disclosure, users can be freed from various problems such as time spent streaming and network environment issues.

The effects of the present disclosure are not limited to those mentioned above, and other effects not mentioned will be apparent to those of ordinary skill in the art from the following description.

### BRIEF DESCRIPTION OF THE DRAWINGS

FIG. 1 is a schematic block diagram of a content providing system according to at least one embodiment of the present disclosure.

FIG. 2 is a flowchart of a service providing procedure according to at least one embodiment of the present disclosure.

FIG. 3 is a diagram illustrating a scheduling method according to at least one embodiment of the present disclosure.

FIG. 4 is a flowchart of the operation of a client terminal for off-demand-based downloading, according to at least one embodiment of the present disclosure.

FIG. 5 is a flowchart of the operation of the client terminal for preventing service failure due to off-demand-based downloading, according to at least one embodiment of the present disclosure.

FIG. 6 is a flowchart of the operation of the client terminal for managing incompletely downloaded content, according to at least one embodiment of the present disclosure.

FIG. 7 is a schematic block diagram of a client terminal according to at least one embodiment of the present disclosure.

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

The description of the present disclosure to be presented below in conjunction with the accompanying drawings is intended to describe exemplary embodiments of the present disclosure and is not intended to represent the only embodiments in which the technical idea of the present disclosure may be practiced.

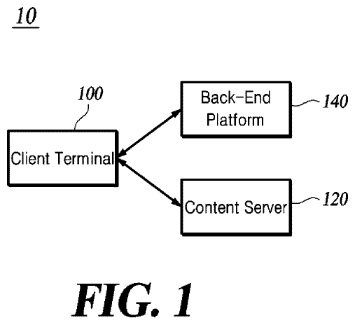

FIG. 1 is a schematic block diagram of a content providing system according to at least one embodiment of the present disclosure.

As shown in FIG. 1, the content providing system 10 may include all or some of a client terminal 100, a content server 120, and a back-end platform 140. Not all of the blocks shown in FIG. 1 are requisite components, and in other embodiments, some of the blocks included in the content providing system 10 may be added, changed, or deleted.

The client terminal 100 is a device that can receive content from the content server 120 by using wireless or wired communication methods and play it. Here, the content may be, but is not limited to, media content. The client terminal 100 may include an application that can receive various services related to the content from the content server 120 and/or the back-end platform 140.

The client terminal 100 may download and/or stream content from the content server 120 for playback. To provide efficient transmission and reception of the content, the content server 120 may be implemented as a content delivery network (CDN) including an original server and one or more cache servers.

The back-end platform 140 may perform user authentication by linking account information with the client terminal 100 and may provide the client terminal 100 with application initial configuration information for service interworking. The back-end platform 140 may provide the client terminal 100 with a playlist including one or more curated lists of contents and a uniform resource locator (URL) for downloading the contents. The curated list may be a curated list of personally recommended content for a user of the client terminal 100 but is not limited to this example.

Meanwhile, although not shown in FIG. 1, in some embodiments, the client terminal 100 may send, and receive responses to, user authentication requests, initial configuration information requests, content list requests, and/or content requests to the content server 120 and/or the back-end platform 140 via an Application Programming Interface gateway (API gateway). Here, the API gateway may serve to integrate end points for requests from the client terminal 100. The API gateway may forward requests received from the client terminal 100 to the content server 120 and/or the back-end platform 140 and may forward responses received from the content server 120 and/or the back-end platform 140 to the client terminal 100. In some embodiments, the API gateway may also process the received request or response and forward it.

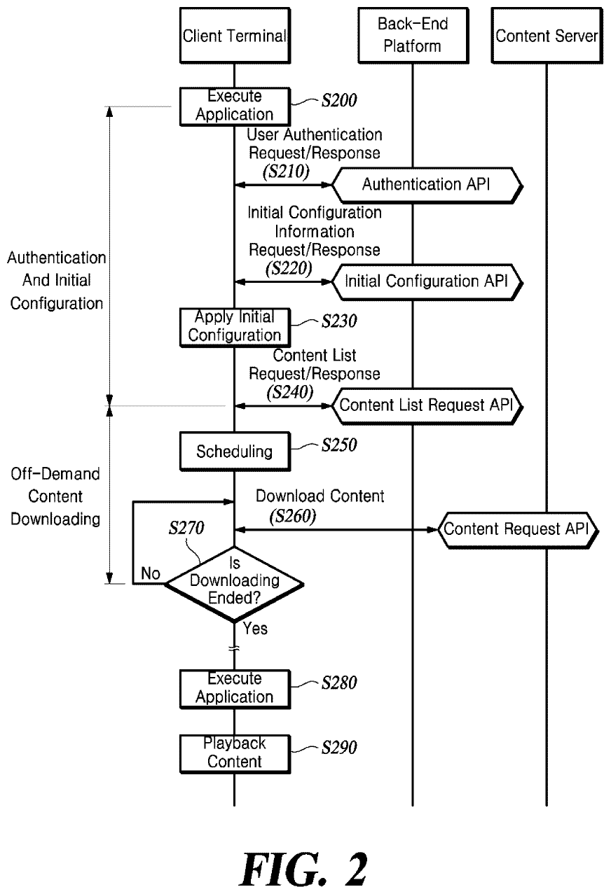

FIG. 2 is a flowchart of a service providing procedure according to at least one embodiment of the present disclosure.

When a service is initiated by the execution of an application installed on the client terminal 100 (S200), the client terminal 100 may call an authentication API to perform user authentication (S210). Here, the user authentication request sent by the client terminal 100 may include user account information.

The client terminal 100 may call the initial configuration API to obtain application initial configuration information for service interworking from the back-end platform 140 (S220). The application initial configuration information may include an identifier assigned to the client terminal 100. The identifier may be, but is not limited to, a unique identifier (unique ID) for a user and/or an application installed in the client terminal 100. The application initial configuration information may further include, for example, configuration information for a pre-download period, configuration information for frames and slots composing the pre-download period, and/or scheduling policies.

The client terminal 100 may apply the received application initial configuration information to the application (S230).

The client terminal 100 may obtain a playlist from the back-end platform 140 by calling a content list request API (S240). Here, the content list request API may be, but is not limited to, an electronic program guide API (EPG API). The playlist may include a list of contents curated through personalized recommendations or the like for the user of the client terminal 100. The playlist may further include a uniform resource locator (URL) for downloading each piece of content, the number of media segments to be pre-downloaded per piece of content, and/or a time value. The time value may be, for example, a time value corresponding to the last download point, to support playback resumption or download resumption functionality for content with a download history. The content may be, but is not limited to, a plurality of different videos, or a plurality of different sections within a single video.

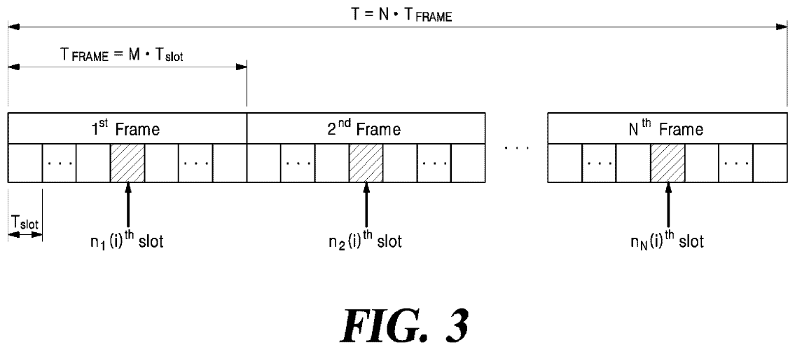

Based on the application initial configuration information, the client terminal 100 may schedule a time period to download the contents in the content list (S250). For example, the client terminal 100 may determine one or more time periods to download the content within a predefined pre-download period. Here, the time periods may be a time periods corresponding to target slots, each determined based on the identifier, among a plurality of slots in each frame of the pre-download period. Specific details of the scheduling method of the client terminal 100 will be described below with reference to FIG. 3.

Within the scheduled time period, the client terminal 100 may download at least some of the content in the content list (S260). The client terminal 100 may call the content request API to download the content from the content server 120. Here, the downloading of the content may be initiated without receiving a download request from the user and may be performed in the background of the client terminal 100.

The client terminal 100 may repeatedly perform downloading of the content within the scheduled time period until a preset download termination condition is satisfied (S270). Here, the download termination condition may include, for example, but is not limited to, the completion of downloading all content in the content list or the end of the pre-download period.

Subsequently, when the application is executed (S280) and content is selected by the client terminal 100 or the user, the client terminal 100 may playback the selected content without a network connection (S290).

FIG. 3 is a diagram illustrating a scheduling method according to at least one embodiment of the present disclosure.

Referring to FIG. 3, a pre-download period may comprise N frames, and each frame may comprise M slots (wherein N and M are natural numbers).

Based on the identifier obtained in the initial configuration procedure, the client terminal 100 may determine, from among the slots in each frame, one or more target slots to perform the content downloading. For example, the target slot number for the i-th client terminal to perform content downloading in the j-th frame may be determined as shown in, but not limited to, Equation 1, and it may vary depending on the scheduling policy of each client terminal 100 or back-end platform 140.

nⱼ(i)=(seed(i)+(j−1)·Δₛₗₒₜ)mod M Equation 1

Here, nⱼ⁽ⁱ⁾ is the target slot number for the i-th client terminal to perform content downloading in the j-th frame, seed(i) is an identifier assigned to the i-th client terminal, and Δₛₗₒₜ is a slot offset to make the target slot number in each frame different.

In an actual service operation environment, the client terminal 100 may fail to download content from a particular slot due to various obstacles. In this case, the target slot allocation method of the present disclosure can provide time diversity to overcome the service failure by adjusting the length of the frame and the number of slots in the frame. For example, assuming that a typical service interruption period due to an infrastructure failure is one hour and the length of a frame is set to one hour, the client terminal 100 may download content in a frame other than the frame suffering from the infrastructure failure.

Meanwhile, the pre-download period, the number of frames within the pre-download period, the length of the frames, the number of slots within each frame, and/or the slot offset, etc. may be set by the back-end platform 140 and instructed to the client terminal 100 via the application initial configuration information, but the present disclosure is not so limited. In one example, the pre-download period may be specified by the user or may be determined autonomously by the client terminal 100 based on, for example, whether the user is using the client terminal 100. As another example, the slot offset may be a value set autonomously by the client terminal 100 or may be a set value included in the installation file of the application.

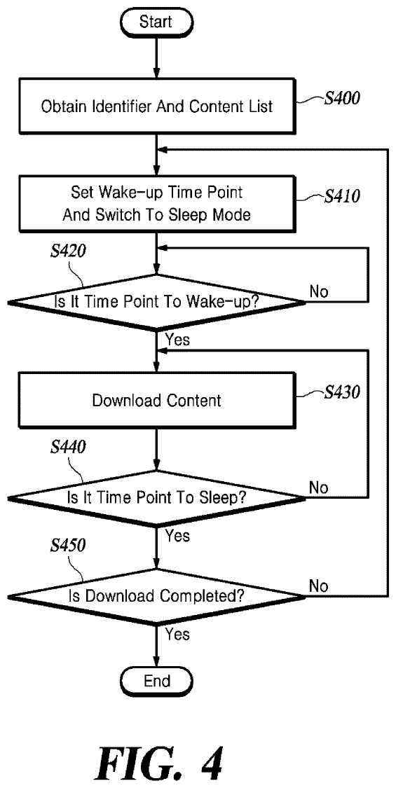

FIG. 4 is a flowchart of the operation of a client terminal for off-demand-based downloading, according to at least one embodiment of the present disclosure.

The client terminal 100 may obtain an assigned identifier and a list of one or more contents curated by personalized recommendations for a user of the client terminal 100 (S400). Here, the identifier and the list of contents may be, but is not limited to, obtained from the back-end platform 140 in an initial configuration procedure following execution of the application providing the content service.

The client terminal 100 may set a wake-up time point for downloading content and may switch to a sleep mode (S410). Here, sleep mode may refer to a state in which off-demand-based downloading is disabled, and wake-up mode may refer to a state in which off-demand-based downloading is enabled. An off-demand-based downloading may refer to a downloading that is initiated without receiving a download request from the user. The client terminal 100 may set a wake-up time point based on the obtained identifier. For example, among the target slots determined in each frame in the pre-download period, the nearest neighboring target slot's start time point after the current time point may be set as the wake-up time point.

The client terminal 100 may continuously monitor time to determine whether the set wake-up time point has been reached (S420). The client terminal 100 may maintain sleep mode until the set wake-up time point has been reached (S420, NO).

When the set wake-up time point is reached (S420, YES), the client terminal 100 may switch from sleep mode to wake-up mode to download at least some of the content in the content list (S430).

The client terminal 100 may continuously monitor time to determine whether a preset sleep time point has been reached (S440). Here, the sleep time point may correspond to the end time point of the target slot. The client terminal 100 may compare the current time point to the end time point of the target slot, or determine that a time corresponding to the length of the target slot has elapsed from the wake-up time point. The client terminal 100 may proceed with downloading the content until the set sleep time point is reached (S440, NO).

Once the set sleep point is reached (S440, YES), the client terminal 100 may check whether the downloading of all content in the content list is complete (S450).

When there is content that has not been completely downloaded by the sleep time point (S450, NO), the client terminal 100 may set the start time point of the target slot in the next frame as the wake-up time point and switch to sleep mode (S410).

Meanwhile, Step S410 to Step S450 illustrated in FIG. 4 may be performed in the background of the client terminal 100.

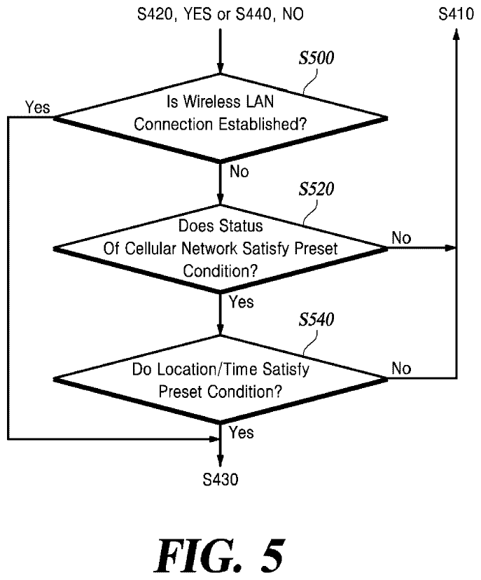

FIG. 5 is a flowchart of the operation of the client terminal for preventing service failure due to off-demand-based downloading, according to at least one embodiment of the present disclosure.

In performing Steps S420 to S440 of FIG. 4, the client terminal 100 may not switch to the wake-up mode even when the wake-up time point is reached, or may switch to the sleep mode even before the sleep time point is reached based on the preset conditions.

Referring to FIG. 5, the client terminal 100 may check whether a wireless LAN (WLAN) connection is established either before initiation of the content downloading at the target slot in the current frame (e.g., when determined to be YES in Step S420), or periodically or aperiodically during the process of content downloading at the target slot in the current frame (e.g., when determined to be NO in Step S440) (S500). For example, the client terminal 100 may check whether a wireless fidelity (Wi-Fi) connection is established through an external device, such as a wireless access point.

When a Wi-Fi connection is established (S500, YES), the client terminal 100 may switch to (or remain in) wake-up mode to download at least some of the content in the content list (S430).

On the other hand, if a WLAN connection is not established (S500, NO), the client terminal 100 may check whether the status of a cellular network satisfies a preset condition (S520). The client terminal 100 may utilize a received signal strength indicator (RSSI) to monitor the network status without requiring control information from a separate server. For example, the client terminal 100 may check whether the radio signal strength of the cellular network satisfies the condition of being at or above a preset strength.

When the status of the cellular network does not satisfy the preset condition (S520, NO), the client terminal 100 may set the start time point of the target slot in the next frame as the wake-up time point and remain in (or switch to) sleep mode (S410).

When the state of the cellular network satisfies the preset condition (S520, YES), the client terminal 100 may check whether the location of the client terminal 100 and/or current time satisfies the preset condition (S540). The client terminal 100 may check whether the location of the client terminal 100 and the current time satisfy the condition that the client terminal 100 is not in a preset download-restricted region and/or download-restricted time zone. While FIG. 5 illustrates that the client terminal 100 checks the location and/or time conditions only if the state of the cellular network satisfies the preset conditions, the present disclosure is not limited to this sequence of events.

When the location of the client terminal 100 and/or current time does not satisfy the preset conditions (S540, NO), the client terminal 100 may set the start time point of the target slot in the next frame as the wake-up time point and remain in (or switch to) sleep mode (S410).

When the location of the client terminal 100 and/or current time satisfies the preset conditions (S540, YES), the client terminal 100 may switch to (or remain in) wake-up mode to download at least some of the content in the content list via the cellular network (S430).

As described above, the client terminal 100 may control the off-demand-based downloading based on whether at least one of the wireless connection status, location, and current time satisfies a preset condition, thereby preventing disruption of on-demand services that need to fulfill real-time requests from users. In particular, the client terminal 100 may prevent failure of a paid service utilizing a cellular network by checking the status of the cellular network or the presence and absence of an event. For example, when a large-scale real-time event such as the World Cup or the Olympics occurs, there may be large requests for on-demand services utilizing the cellular network. In this case, the client terminal 100 may control the off-demand-based downloading service through terminal location information and/or time information that it may directly obtain.

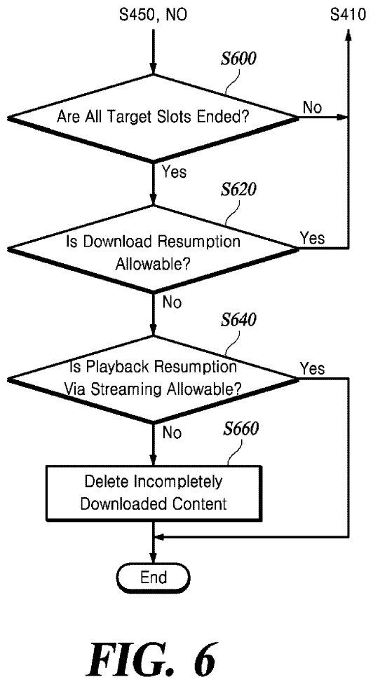

FIG. 6 is a flowchart of the operation of the client terminal for managing incompletely downloaded content, according to at least one embodiment of the present disclosure.

In performing Step S450 of FIG. 4, the client terminal 100 may manage content that has not been completely downloaded until the end of the target slot in the current frame based on preset conditions.

When there is content that has not been completely downloaded until the end of the target slot in the current frame (S450, NO), the client terminal 100 may check whether all target slots within the pre-download period have ended (S600). In one example, the client terminal 100 may check whether the current frame is the last frame within the pre-download period. As another example, the client terminal 100 may check whether the time difference between the current time point and the end time point of the pre-download period is or less than a preset threshold.

When not all target slots are ended (S600, NO), the client terminal 100 may set the start time point of the target slot in the next frame as the wake-up time point and switch to sleep mode (S410).

When all target slots have ended (S600, YES), the client terminal 100 may check whether content download resumption is allowable in another pre-download period (S620). For example, if the application supports a download resumption feature and/or the download resumption feature is allowed by the user, the client terminal 100 may determine that content download resumption in another pre-download period is allowable.

When a content download resumption is allowable (S620, YES), the client terminal 100 may set the start time point of the target slot determined in the first frame in the next pre-download period as the wake-up time point and switch to sleep mode (S410). Accordingly, even if there is incompletely downloaded content in a particular pre-download period, the client terminal 100 may download the remainder of the incomplete content in the next pre-download period. The next pre-download period may be, for example, but not limited to, a pre-download period specified for another day.

When the content download resumption is not allowable (S620, NO), the client terminal 100 may check whether a playback resumption of the content via streaming is allowable (S640). For example, the client terminal 100 may determine that the playback resumption of the content is allowable if the application program supports the playback resumption and/or if the playback resumption is allowed by the user.

When the playback resumption via streaming is not allowable (S640, NO), the client terminal 100 may delete the incomplete content that has not been completely downloaded within the pre-download period (S660).

On the other hand, when the playback resumption via streaming is allowable (S640, YES), the client terminal 100 may not delete the incomplete content that has not been completely downloaded within the pre-download period. Thereafter, when that incomplete content is selected as content to playback, the client terminal 100 may playback the remainder of the incomplete content via streaming.

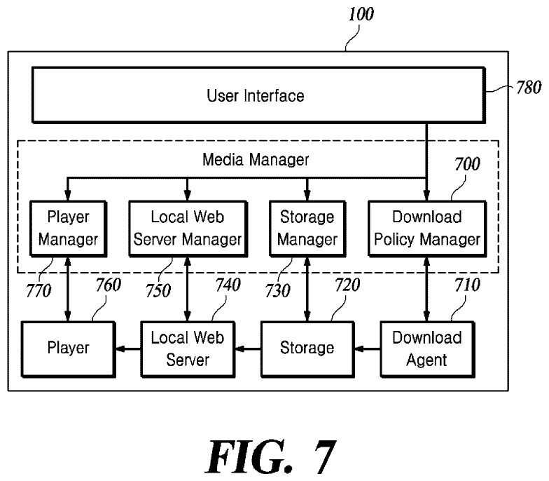

FIG. 7 is a schematic block diagram of a client terminal according to at least one embodiment of the present disclosure.

As shown in FIG. 7, a client terminal 100 may include all or part of a download policy manager 700, a download agent 710, storage 720, a storage manager 730, a local web server 740, a local web server manager 750, a player 760, a player manager 770, and a user interface 780. Not all of the blocks as illustrated in FIG. 7 are requisite components, and in other embodiments, some of the blocks included in the client terminal 100 may be added, changed, or deleted. The client terminal 100 and the respective components thereof may be implemented as hardware or software, or hardware and software combined. Additionally, each component may be functionally implemented by software, and a processor may execute the function by software for each component when implemented.

The download policy manager 700 may manage policies and settings for downloading content. The download policy manager 700 may determine which content to download and the time period at which to download that content. To do so, the download policy manager 700 may receive and manage application initial configuration information and playlists from the back-end platform 140. Here, the application initial configuration information may include an identifier assigned to the client terminal 100. Additionally, the playlist may include a list of one or more contents curated by personalized recommendations for the user.

The download policy manager 700 may use the obtained application initial configuration information to determine a time period for the download agent 710 to download content within the playlist. Based on the determined time period, the download policy manager 700 may switch the mode of operation of the download agent 710.

In one example, the download policy manager 700 may control the download agent 710 to switch from a sleep mode to a wake-up mode at each time period corresponding to a target slot determined based on an identifier assigned to the client terminal 100, among a plurality of slots composing each of the frames included in a predetermined pre-download period. As another example, if there exists content that has not been completely downloaded until the end of the target slot in a particular frame, the download policy manager 700 may set the start time point of the next frame's target slot as a wake-up time point for the download agent 710 and switch the download agent 710 to sleep mode. As another example, if at least one of the wireless connection status of the client terminal 100, the location of the client terminal 100, and the current time satisfies a preset condition within a time period corresponding to the target slot in a particular frame, the download policy manager 700 may set the start time point of the next frame's target slot as the wake-up time point of the download agent 710 and switch the download agent 710 to the sleep mode.

The download agent 710 may pre-download from the content server 120 all or a portion of the data for playback of each of the contents in the playlist and store it in the storage 720. Here, the data for playback of the content may include media segments and/or content attributes that constitute the content. The media segments may be composed of various media formats, such as mp4, fragmented mp4 (fmp4), or transport stream (ts), and the content attributes may include, but are not limited to, video/audio configuration information, such as a PAT or PMT, and a manifest file containing an index of the segments, etc.

The download agent 710 may pre-download content in the content list from the content server 120 and store it in the storage 720 without requiring a content request from the user. On the other hand, when incompletely downloaded content is selected as content to playback, the download agent 710 may download the remainder of the content via streaming.

Further, the download agent 710 may manage the data stored in the storage 720. The download agent 710 may delete unneeded data from the data stored in the storage 720 based on preset conditions. For example, if there is incomplete content that has not been completely downloaded within a particular pre-download period, and if the playback resumption via streaming or download resumption in another pre-download period is not allowable, the download agent 710 may delete the data for the incomplete content from the storage 720.

The storage 720 may temporarily or semi-permanently store media segments and/or content attributes downloaded by the download agent 710. The storage manager 730 may check the download status and delete unneeded data from the data stored in the storage 720.

The local web server 740 may transfer the media segments and/or content attributes stored in the storage 720 to the player 760 to support content playback on the player 760, and the local web server manager 750 may control settings such as the port of the local web server 740.

The player 760 may use media segments obtained from the local web server 740 to perform functions such as playback of content, and the player manager 770 may control the player 760 based on the download status of the content and/or commands issued from the user interface 780.

The player 760 may include a buffer, and may only begin playback of content once a certain amount of segments has been filled in the buffer to overcome network jitter. When any content within the content list is selected as content to be played back or switched to, the local web server 740 may pass data pre-stored in the storage 720 to the player 760 to quickly satisfy the conditions for playback on the player 760.

In general, communication between the client terminal 100 and the content server 120 is made via a public network, and it would have been difficult to ensure reliable high-speed transmission. However, communication via the local web server 740 according to the present disclosure occurs inside the client terminal 100, which can sufficiently ensure stable high-speed transmission and does not cause head of line (HOL) blocking issues. Accordingly, the local web server 740 can quickly fill the buffer of the player 760 with media segments pre-stored in the storage 720, thereby dramatically reducing the time required for buffering.

According to at least one embodiment of the present disclosure, by using the local web server 740, interaction can be minimized between the player 760 and a service infrastructure, such as the content server 120. Furthermore, the player 760 may be implemented simply by utilizing any known players, as it only needs to request consecutive segments from the local web server 740.

The user interface 780 may be a physical medium or a virtual medium implemented for temporary or permanent access to enable interaction between a user and the client terminal 100.

The user interface 780 may include at least one input means that may be manipulated by the user and at least one output means that displays the results of the user's utilization. The user interface 780 may include at least one object designed to interact with the user, such as a display screen, a keyboard, a mouse, text, or icons.

The user interface 780 may display a list of one or more content curated with personalized recommendations for the user and/or receive from the user a selection of content the user wishes to view. In at least one embodiment, the user interface 780 may receive from the user an input of content playback request or switching request. Here, the gesture input may include at least one of swipe, flick, pan, tap, double tap, drag and drop, and pinch in and out. For example, the user may request to switch to a different channel via a swipe motion in the first direction, and may request to switch to different content within the same channel via a swipe motion in a second direction. Here, each channel may be composed of a particular genre of content, such as entertainment, drama, movies, and/or documentaries. The first direction and the second direction may each be in a vertical direction (i.e., up or down) or a horizontal direction (i.e., left or right), but are not limited to these examples. As another example, the user may request to playback or switch content by tapping or double-tapping at least one side of the screen displayed by the user interface 780.

As described above, devices and/or methods according to some embodiments of the present disclosure can provide an off-demand-based download service that can be initiated without a user request. The off-demand service can allow for more reliable management of network traffic compared to an on-demand service. Specifically, on-demand services require content to be provided immediately upon user demand, which makes it difficult to control traffic. In contrast, with off-demand services, network traffic can be managed reliably because the time when the service is provided can be made different from the time when the traffic is generated on the network.

For example, the benefits of traffic control over off-demand traffic, compared to the case where off-demand traffic is generated randomly and without any control, can be summarized as follows.

First, when the number of users receiving content by an on-demand service and the number of users receiving content by an off-demand service are referred to as Non-demand and Noff-demand, respectively, the utilization of the on-demand service may occur independently of that of the off-demand service. A single device may playback on-demand content and download off-demand content in the background at the same time. Thus, in a worst-case scenario, users of both services may utilize the services simultaneously. In this case, if the average transfer rates served through the content server 120 are called R_{on-demand} and R_{off-demand}, respectively, the worst-case service capacity available in the infrastructure is R_{on-demand}×N_{on-demand}+R_{off-demand}×N_{off-demand}.

In contrast, with off-demand traffic control, pre-download period configuration can be utilized to encourage off-demand content downloading during times when there is little on-demand traffic, and target slot assignments can be utilized to evenly distribute users downloading at specific slots to encourage distributed traffic among the users. When the number of frames within the pre-download period and the number of slots within each frame are N_{frame} and M, respectively, the minimum transmission amount of the content server 120 can be reduced to (R_{off-demand}×N_{off-demand})/(M×N_{frame}) with the peak transmission amount being R_{on-demand}×N_{on-demand}, which can be determined by on-demand traffic alone.

The devices or methods according to the present disclosure may have the respective components arranged to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Although the steps in the respective flowcharts/timing charts are described in this specification as being sequentially performed, they merely instantiate the technical idea of some embodiments of the present disclosure. Therefore, a person having ordinary skill in the pertinent art to the respective embodiments could perform the steps without departing from the idea and scope of the embodiments by changing the sequences described in the respective flowcharts/timing charts or by performing two or more of the steps in parallel, and hence the steps in the respective flowcharts/timing charts are not limited to the illustrated chronological sequences.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method of operating a terminal for pre-downloading content ahead of a user's request, the method comprising:
obtaining an identifier assigned to the terminal;
obtaining a list of one or more contents curated through personalized recommendations for the user; and
downloading at least some of the one or more contents in one or more time periods which are determined based on the identifier within a predefined pre-download period.

2. The method of claim 1, wherein the identifier and the list are obtained in an initial configuration procedure following execution of an application installed in the terminal.

3. The method of claim 1, wherein the downloading is initiated without receiving a download request from the user.

4. The method of claim 1, wherein:
the time periods include target slots, each determined based on the identifier from among a plurality of slots in each frame of the pre-download period,
the downloading comprises switching between a wake-up mode in which pre-downloading is enabled and a sleep mode in which pre-downloading is disabled, based on a wake-up time point and a sleep time point,
the sleep time point is set based on an end time point of the target slot in a current frame, and
the wake-up time point is set based on a start time point of a target slot of a next frame and whether there is content that has not been completely downloaded by the sleep time point.

5. The method of claim 4, wherein the downloading further comprises:
switching to the sleep mode even before the end time point or remaining in the sleep mode even after the start time point, based on whether at least one of a wireless connection status of the terminal, a location of the terminal, or a current time satisfies a predetermined condition.

6. The method of claim 1, further comprising, after the downloading:
deleting incomplete content which has not been completely downloaded within the pre-download period.

7. The method of claim 1, further comprising, after the downloading:
downloading a remaining portion of incomplete content, which has not been completely downloaded within the pre-download period, in a next pre-download period.

8. The method of claim 1, further comprising, after the downloading:
based on whether incomplete content, which has not been completely downloaded within the pre-download period, is selected as playback content, streaming playback of a remaining portion of the incomplete content.

9. A non-transitory computer-readable recording medium storing instructions for causing, when executed by a computer, the computer to perform the method according to claim 1.

10. A terminal, comprising:
a download policy manager configured to obtain an identifier assigned to the terminal and a list of one or more contents curated through personalized recommendations for a user of the terminal; and
a download agent configured to download at least some of the one or more contents in one or more time periods which are determined based on the identifier within a predefined pre-download period.
